(19) United States
(12) Patent Application Publication
(10) Pub. No.: US 2004/0145704 A1
(43) Pub. Date: Jul. 29, 2004

(54) Chiral laser projection display apparatus and method

(76) Inventors: Victor Il?apos;ich Kopp, Flushing, NY (US); Azriel Zelig Genack, New York, NY (US)

Correspondence Address: Edward Etkin, Esq., Suite 3C, 4804 Bedford Avenue, Brooklyn, NY, 11235, US

(21) Appl. No.: 10/724,373

(22) Filed: Nov. 29, 2003

Related U.S. Application Data
(60) Provisional application No. 60/430,018, filed on Nov. 29, 2002.

(51) Int. Cl. G03B 21/00

(52) U.S. Cl. 353/31

(57) ABSTRACT

A thin chiral film display is provided in several embodiments. In one inventive embodiment, red, green and blue chiral film lasers are placed in front of corresponding red, green and blue LCD panels connected to a video signal source. The resulting red, green and blue signal components are combined and output through a projection lens onto a screen or other surface. In another inventive embodiment, red, green and blue chiral film lasers are pixellated and each connected to a video signal source. The pixels are under the control of the video signal source and serve to replace the LCDs from the previously described embodiment. The resulting red, green and blue signal components are combined and output through a projection lens onto a screen or other surface. In another inventive embodiment, red, green and blue chiral film lasers are pixellated and each connected to a video signal source. The pixellated chiral film lasers are then stacked on to of one another to form a combined color signal from resulting red, green and blue signal components. The combined color signal is then output through a projection lens onto a screen or other surface. In an alternate embodiment of the invention, the projection lens is eliminated.

### CROSS REFERENCE TO RELATED APPLICATIONS

The present patent application claims priority from the commonly assigned U.S. provisional patent application S/No. 60/430,018 entitled “Chiral Laser Projection Display Apparatus and Method” filed Nov. 29, 2002.

### FIELD OF THE INVENTION

The present invention relates generally to projection displays, and more particularly to a projection display utilizing thin chiral film lasers.

### BACKGROUND OF THE INVENTION

Various types of projection displays have been in use for many years. Applications for projection display technologies include, but are not limited to: sophisticated movie theaters, business and education presentation products, and high-end home theaters.

Exemplary previously known projection display systems are shown in FIGS. 4 and 5. While modern projection systems are superior to ones used when the video projection technology was first introduced, they continue to suffer from a number of significant drawbacks. Currently, projectors are powered by projection lamps—white light sources that require splitting of the light into its RGB components, and then separately modulating the three constituent colors and then recombining the image (as shown in FIG. 4 for typical liquid crystal or micro-electromechanical structure (MEMS)-based devices).

Collimating, splitting, focusing, recombining, filtering and polarizing light all produce losses that force designers to use higher power light sources, and additionally, to increase the power consumption due to cooling requirements. This increases the necessary size and weight of projection systems. Furthermore, the necessary optics, such as mirrors and polarizers further increase the complexity, size, weight and expense of projection systems. Moreover, such systems are very fragile, even in portable configurations. Finally, image quality, saturation, and intensity are constantly a challenge for all but the most complex and expensive displays. In particular, dark colors such as black and dark gray pose a significant challenge for all currently available projection systems.

As a result, various projection system technologies are forced to sacrifice certain advantageous characteristics to optimize a particular desirable parameter. For example, high-pressure mercury displays are color balanced at the expense of brightness, small arc metal halide systems have more limited life, but a larger projection arc, while Cermax-type xenon projectors have good color and size at expense of wattage and price.

It would thus be desirable to provide a projection apparatus and method that is simple to implement and manufacture, relatively inexpensive, light, small, and reliable. It would further be desirable to provide a projection apparatus and method that provides low power consumption and superior image quality and intensity.

### BRIEF DESCRIPTION OF THE DRAWINGS

In the drawings, wherein like reference characters denote elements throughout the several views:

FIG. 1 is a schematic diagram of a first embodiment of a chiral laser projection display of the present invention wherein three chiral lasers are used as light sources for corresponding LCD panels;

FIG. 2 is a schematic diagram of a second embodiment of a chiral laser projection display of the present invention wherein three chiral lasers are pixellated and are used as light and image sources;

FIG. 3 is a schematic diagram of a third embodiment of a chiral laser projection display of the present invention wherein three chiral lasers are pixellated and stacked to produce a flat projection display;

FIG. 4 is a schematic diagram of a first prior art projection system; and

FIG. 5 is a schematic diagram of a second prior art projection system.

### SUMMARY OF THE INVENTION

The present invention is directed to a novel projector display utilizing chiral lasers to achieve vastly superior characteristics and operational parameters in most respects as compared to previously known projection systems. Chiral lasers produce broad area lasing from a thin polymeric film at low pump power thus significantly reducing power consumption. Lasing can be set to any frequency throughout the visible to give true colors and wide area coherence will provide uniform light across each pixel of a display. The laser output is naturally polarized, providing additional efficiency. A chiral laser itself is a low cost device that can be made via web-based processing and is compatible with OLED processing currently being developed. Because chiral lasers may be built as polymeric film, they are lightweight and can thus be contoured and/or made flexible. Depending on configuration, chiral lasers may either be optically pumped via an optical pump or electronically pumped.

In a first embodiment of the inventive chiral laser projection display, utilizes a set of three LCD panels (red, green and blue) connected to a signal source, with a corresponding color chiral laser behind each panel. The light from each chiral laser passes through each panel and is combined by a combiner device (such as a dichroic cube) and then output through a focusing lens.

In a second embodiment of the inventive chiral laser projection display, which is similar in basic arrangement to first embodiment described above, the three LCD panels are eliminated by utilizing a set of novel pixellated red, green, and blue chiral lasers.

In a third embodiment of the inventive chiral laser projection display, pixellated red, green, and blue chiral lasers are stacked on top of one another (and are transparent to the color of the laser behind it) to form a flat projection display that does not require a light combination device.

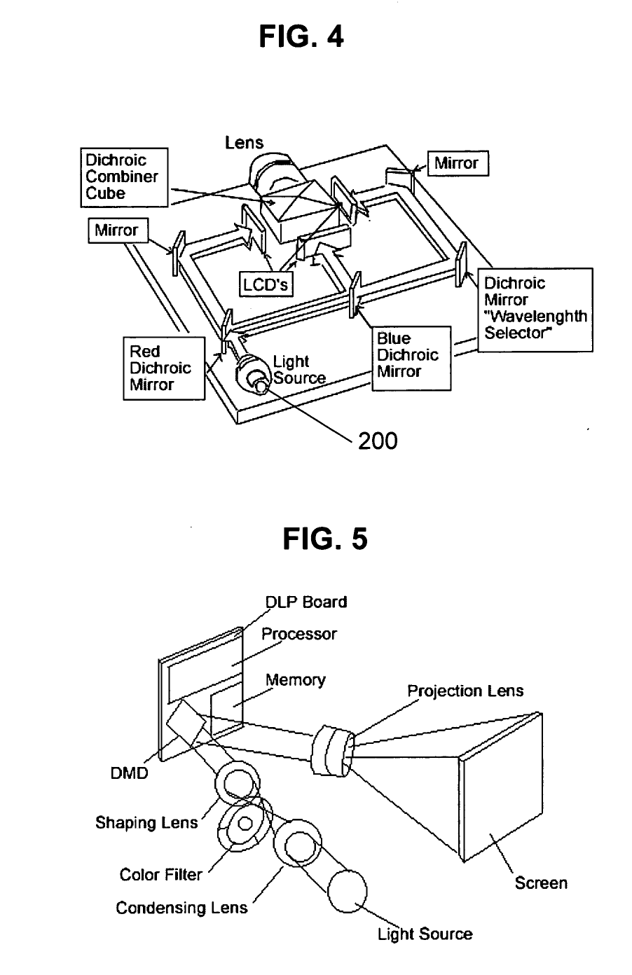

In a fourth embodiment of the inventive chiral laser projection display, which is similar in basic arrangement to the prior art display of FIG. 4, red, green, and blue chiral lasers are used to replace the while light source, while five dichroic mirrors (as well as associated cooling devices, polarizers, etc) are utilized in the same manner as with previously known projectors.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

Before describing the present invention in greater detail, it would be helpful to provide definitions of common terms utilized in the dielectric lasing art. “Chiral” materials are not symmetrical, that is they are not identical to their mirror images. Cholesteric materials, such as cholesteric liquid crystals (hereinafter “CLCs”), have multiple molecular layers where molecules in the different layers are oriented on average at a slight angle relative to molecules in other layers. Molecules in consecutive layers are rotated slightly relative to those in the preceding layer. Thus, the average direction of the molecules, known as the “director”, rotates helically throughout the cholesteric material. A pitch of a cholesteric material is defined as a thickness of the material in which the director rotates a full 360 degrees. Cholesteric structures also have a property called “handedness”—they may be right-handed or left-handed depending on the direction of rotation of the molecules from layer to layer. The handedness of a cholesteric structure influences the circular polarization and amplitude of light passing through the structure.

Small, inexpensive laser devices utilizing chiral materials are described in a commonly assigned co-pending U.S. patent application entitled “Stop Band Laser Apparatus and Method” (Ser. No. 09/919,662), which discloses a novel band gap laser with increased output power and low lasing threshold with improved control over the spatial, spectral, and temporal lasing parameters. A commonly assigned U.S. Pat. No. 6,404,789, entitled “Chiral Laser Apparatus and Method,” also discloses a variety of electrically and optically pumped advantageous chiral lasers based on cholesteric liquid crystal (CLC) structures.

The essence of the present invention is the utilization of chiral lasers to construct a projector display with vastly superior characteristics and operational parameters in most respects as compared to previously known projection systems. Chiral lasers produce broad area lasing from a thin polymeric film at low pump power thus significantly reducing power consumption. Lasing can be set to any frequency throughout the visible to give true colors and wide area coherence will provide uniform light across each pixel of a display. The laser output is naturally polarized, providing additional efficiency. A chiral laser itself is a low cost device that can be made via web-based processing and is compatible with OLED processing currently being developed. Because chiral lasers may be built as polymeric film, they are lightweight and can thus be contoured and/or made flexible. Depending on configuration, chiral lasers may either be optically pumped via an optical pump or electronically pumped.

In summary, in a first embodiment of the inventive chiral laser projection display, utilizes a set of three LCD panels (red, green and blue) connected to a signal source, with a corresponding color chiral laser behind each panel. The light from each chiral laser passes through each panel and is combined by a combiner device (such as a dichroic cube) and then output through a focusing lens.

In a second embodiment of the inventive chiral laser projection display, which is similar in basic arrangement to first embodiment described above, the three LCD panels are eliminated by utilizing a set of novel pixellated red, green, and blue chiral lasers.

In a third embodiment of the inventive chiral laser projection display, pixellated red, green, and blue chiral lasers are stacked on top of one another (and are transparent to the color of the laser behind it) to form a flat projection display that does not require a light combination device.

In a fourth embodiment of the inventive chiral laser projection display, which is similar in basic arrangement to the prior art display of FIG. 4, red, green, and blue chiral lasers are used to replace the while light source, while five dichroic mirrors (as well as associated cooling devices, polarizers, etc) are utilized in the same manner as with previously known projectors.

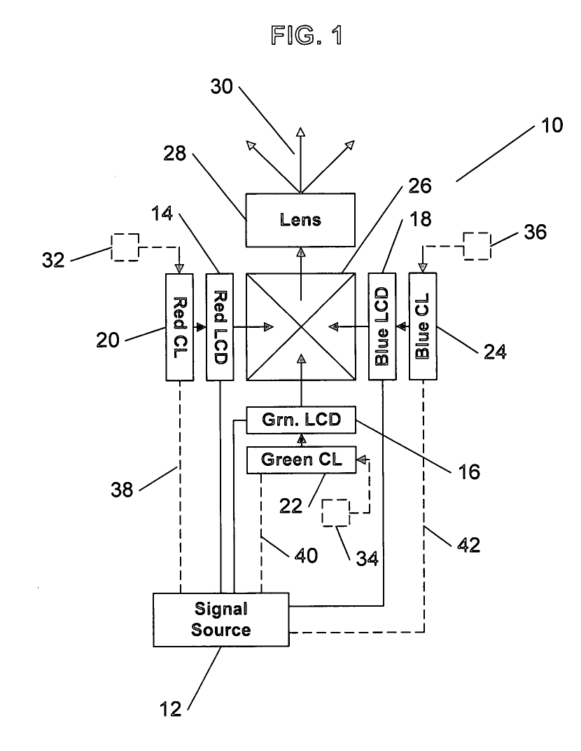

The advantages of the various embodiments of the inventive chiral laser display of FIGS. 1-3 include, but are not limited to:

Directional coherent emission from the RGB chiral laser elements;

Low threshold: reduced power consumption for lighting;

Polarized emission;

Output tunable across visible spectrum;

True color sources for projectors;

Elimination of necessity for color wheel and filters;

Uniform light source across displays;

Reduced power consumption for cooling: elimination of cooling system reduces noise, size, cost, weight and complexity and increases reliability; and

Elimination of optical components: reduced weight, size, complexity, fragility, and expense while reliability is improved.

The advantages of the fourth embodiment of the inventive chiral laser display of FIG. 4 (where the light source is replaced by chiral lasers) include, but are not limited to:

Low threshold: reduced power consumption for lighting;

Output tunable across visible spectrum;

True color sources for projectors;

Uniform light source across displays; and

Reduced power consumption for cooling: elimination of cooling system reduces noise, size, cost, weight and complexity and increases reliability.

Referring now to FIG. 1, a first embodiment of the inventive chiral laser display projector is shown as a chiral display projector 10. The chiral projector 10 includes a signal source 12, which serves as a source of the video signal being projected. The signal source 12 is connected to a red LCD panel 14, a green LCD panel 16, and a blue LCD panel 18 and transmits the appropriate color component of the signal to each LCD. Red, Green, and Blue chiral lasers 20, 22, and 24, respectively, are placed proximal to the corresponding LCD panels 14, 16, and 18. The chiral lasers 20, 22, and 24 serve as excellent light sources for the LCD panels 14, 16, and 18. A light combination device 26, such as a dichroic combiner cube, combines the RGB components of the light emitted through the LCD panels and outputs them through a focusing lens 28 as display output 30. Display output 30 can be projected onto a remote screen or other surface (not shown) in a front projection configuration, or onto a diffuser plate (not shown) placed between the projector 10 and the viewers, in a rear projection configuration.

The chiral lasers 20, 22, and 24 may be optically pumped, in which case they each incorporate a corresponding respective optical pump 32, 34, and 36, or electronically pumped, in which case the signal source 12 also serves as an electronic pump (when connected to the chiral lasers 20, 22, and 24 via corresponding respective links 38, 40, 42).

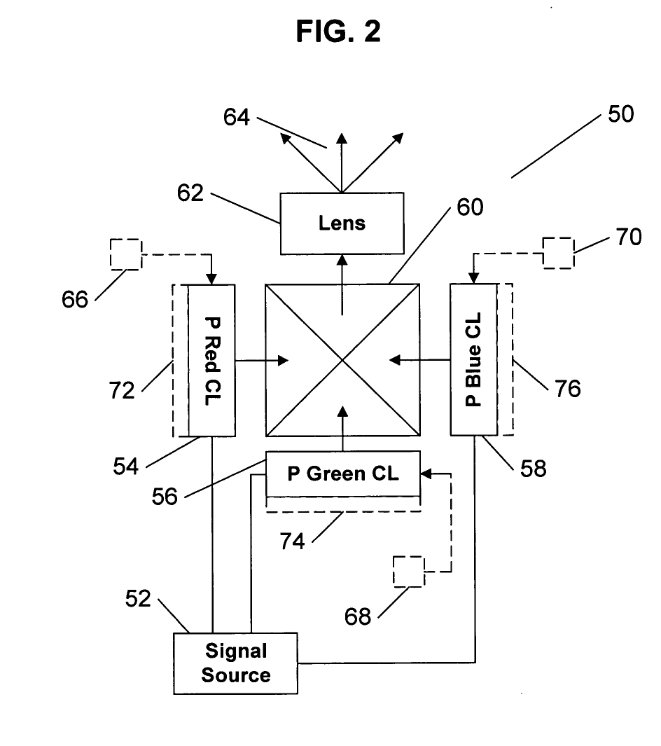

Referring now to FIG. 2, a second embodiment of the inventive chiral laser display projector is shown as chiral display projector 50. The chiral projector 50 includes a signal source 52, which serves as a source of the video signal being projected. The signal source 52 is connected to red, green and blue pixellated chiral lasers 54, 56, and 58, respectively.

The chiral lasers 54, 56, and 58, may be optically pumped, in which case they each incorporate a corresponding respective optical pump 66, 68 and 70, or electronically pumped, in which case the signal source 52 also serves as an electronic pump for each respective chiral laser.

Pixellation of the chiral lasers eliminates the need for separate LCD panels. Pixellation may be accomplished through a variety of techniques depending on whether the chiral lasers 54, 56, and 58 are optically or electronically pumped. Preferably, each pixellated chiral laser 54, 56, and 58 incorporates a corresponding respective pixellator 72, 74, and 76, that functions in a manner determined by the pumping configuration of the chiral lasers. For example, in the optical pumping configuration, the pixellators 72, 74, and 76 each serve as a selectively operable electrode array to suppress lasing in desired potions of each pixellated laser 54, 56, 58, thus turning “off” undesirable pixels as necessary, while in the electronic pumping configuration, the pixellators 72, 74, and 76 each serve as a selectively operable electrode array to induce lasing in selected regions of the pixellated lasers 54, 56, 58, thus turning desirable pixels “on”. Other pixellation approaches may be implemented as a matter of design choice without departing from the spirit of the present invention.

The signal source 52 transmits the appropriate color component data of the signal to each pixellated chiral laser 54, 56 and 58. A light combination device 60, such as a dichroic combiner cube, combines the RGB components of the light emitted from the pixellated lasers 54, 56, 58 and outputs them through a focusing lens 62 as display output 64. Display output 64 can be projected onto a remote screen or other surface (not shown) in a front projection configuration, or onto a diffuser plate (not shown) placed between the projector 50 and the viewers, in a rear projection configuration.

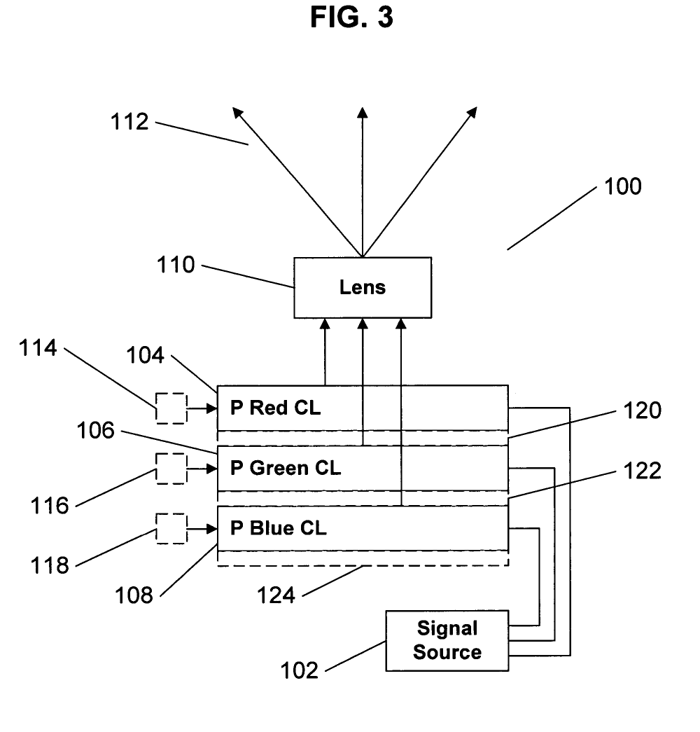

Referring now to FIG. 3, a third embodiment of the inventive chiral laser display projector is shown as chiral display projector 100. The chiral projector 100 includes a signal source 102, which serves as a source of the video signal being projected. The signal source 102 is connected to red, green and blue pixellated chiral lasers 104, 106, and 108, respectively that are stacked on top of one another.

The chiral lasers 104, 106, and 108, may be optically pumped, in which case they each incorporate a corresponding respective optical pump 114, 116 and 118, or electronically pumped, in which case the signal source 102 also serves as an electronic pump for each respective chiral laser.

Pixellation of the chiral lasers eliminates the need for separate LCD panels. Pixellation may be accomplished through a variety of techniques depending on whether the chiral lasers 104, 106, and 108 are optically or electronically pumped. Preferably, each pixellated chiral laser 104, 106, and 108 incorporates a corresponding respective pixellator 120, 122, and 124, that functions in a manner determined by the pumping configuration of the chiral lasers. For example, in the optical pumping configuration, the pixellators 120, 122, and 124, each serve as a selectively operable electrode array to suppress lasing in desired potions of each pixellated laser 104, 106, and 108, thus turning “off” undesirable pixels as necessary, while in the electronic pumping configuration, the pixellators 120, 122, and 124, each serve as a selectively operable electrode array to induce lasing in selected regions of the pixellated lasers 104, 106, and 108, thus turning desirable pixels “on”. Other pixellation approaches may be implemented as a matter of design choice without departing from the spirit of the present invention.

The exact position of each pixellated chiral laser in the stack is selected as a matter of design choice as long as each laser is transparent to the color of light emitted from the chiral laser behind it. For example, in the stack configuration shown in FIG. 3, the red pixellated chiral laser 104 must be transparent to blue and green light, while the green pixellated chiral laser 106 must be transparent to blue light.

The signal source 102 transmits the appropriate color component of the signal to each pixellated chiral laser 104, 106 and 108. The stack configuration of the pixellated chiral lasers eliminates the need for a light combination device. The light emitted from the pixellated chiral lasers 104, 106 and 108 is transmitted through a focusing lens 110 as display output 112. Display output 112 can be projected onto a remote screen or other surface (not shown) in a front projection configuration, or onto a diffuser plate (not shown) placed between the projector 100 and the viewers in a rear projection configuration.

Referring now to FIG. 4, the chiral lasers may be advantageously utilized to simply replace the light source 200 to provide a high quality and efficiency, low noise, low heat and low power consumption light source for a conventional projector system.

It should be noted that while focusing lenses 28, 62 and 110 are shown in the various embodiments of FIGS. 1-3, by selecting appropriate chiral laser characteristics, the inventive chiral projectors can be readily configured, as a matter of design choice, eliminate these optics entirely.

Furthermore, while the various embodiments of the present invention have been discussed with reference to CLC or thin film chiral lasers, it should be noted that other forms of chiral lasers can be advantageously configured to function in the various embodiments of the present invention as a matter of design choice. For example, a single chiral fiber laser, such as disclosed in the co-pending commonly assigned U.S. patent application entitled “Chiral Fiber Laser Apparatus and Method” (Ser. No. 10/299,651), or an array of chiral fiber lasers, may be readily adapted to serve as a red green or blue laser in each of FIGS. 1 to 3.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps, which perform substantially the same function in substantially the same way to achieve the same results, are within the scope of the invention. It is the intention, therefore, to be limited only as indicated by the scope of the claims appended hereto.

We claim:

1. A chiral laser projection apparatus for projecting a display image derived from plural component color signals produced by a signal source connected thereto, comprising:
a plurality of display panels, each plural display panel configured to receive and display a particular plural component color signal;
a plurality of chiral lasers; each corresponding to a particular plural display panel and each positioned proximal thereto, wherein said plural chiral lasers are operable to emit light radiation through said plural display panels to form a plurality of color light beams, each plural color beam being representative of a particular color component of the display image; and
combining means for combining said plural color light beams into the display image for projection onto a surface.

2. The chiral laser projection apparatus of claim 1, wherein said plurality of display panels comprises a plurality of LCD panels.

3. The chiral laser projection apparatus of claim 2, wherein said plural component color signals comprise red, green and blue color signal components and wherein said plural LCD panels comprise: a red LCD panel, a green LCD panel, and a blue LCD panel.

4. The chiral laser projection apparatus of claim 1, wherein said plurality of chiral lasers comprises a plurality of CLC film lasers.

5. The chiral laser projection apparatus of claim 4, wherein said plural component color signals comprise red, green and blue color signal components, and wherein said plural CLC film lasers comprise: a red CLC film laser, a green CLC film laser, and blue CLC film laser.

6. The chiral laser projection apparatus of claim 1, wherein said plural chiral lasers each comprise means for optically pumping thereof.

7. The chiral laser projection apparatus of claim 1, further comprising electronic pumping means for electronically pumping said plural chiral lasers.

8. The chiral laser projection apparatus of claim 7, wherein said electronic pumping means comprises the signal source connected to said plural chiral lasers.

9. The chiral laser projection apparatus of claim 1, wherein said combining means comprises a dichroic combiner cube.

10. The chiral laser projection apparatus of claim 1, further comprising focusing means for focusing the display image in conjunction with said combining means.

11. The chiral laser projection apparatus of claim 1, wherein said surface comprises one of: a screen and a diffuse panel.

12. A chiral laser projection apparatus for projecting a display image derived from plural component color signals produced by a signal source connected thereto, comprising:
a plurality of pixellated chiral lasers, each plural pixellated chiral laser configured to receive one of the plural component color signals, wherein said plural chiral lasers are operable to emit light radiation therefrom to form a plurality of color light beams, each plural color beam being representative of a particular color component of the display image; and
combining means for combining said plural color light beams into the display image for projection onto a surface.

13. The chiral laser projection apparatus of claim 12, wherein said plurality of pixellated chiral lasers comprises a plurality of CLC film pixellated lasers.

14. The chiral laser projection apparatus of claim 12, wherein said plural component color signals comprise red, green and blue color signal components, and wherein said plural CLC film pixellated lasers comprise: a red CLC film pixellated laser, a green CLC film pixellated laser, and blue CLC film pixellated laser.

15. The chiral laser projection apparatus of claim 12, wherein each said plural pixellated chiral laser comprises pixellation means for selectively causing each said plural pixellated chiral laser to only emit light radiation from a predefined portion thereof.

16. The chiral laser projection apparatus of claim 12, wherein said plural pixellated chiral lasers comprise means for optically pumping thereof.

17. The chiral laser projection apparatus of claim 12, further comprising electronic pumping means for electronically pumping said plural pixellated chiral lasers.

18. The chiral laser projection apparatus of claim 17, wherein said electronic pumping means comprises the signal source connected to said plural pixellated chiral lasers.

19. The chiral laser projection apparatus of claim 12, wherein said combining means comprises a dichroic combiner cube.

20. The chiral laser projection apparatus of claim 12, further comprising focusing means for focusing the display image in conjunction with said combining means.

21. The chiral laser projection apparatus of claim 12, wherein said surface comprises one of: a screen and a diffuse panel.

22. A chiral laser projection apparatus for projecting a display image derived from plural component color signals produced by a signal source connected thereto, comprising:
a plurality of pixellated chiral lasers, each plural pixellated chiral laser configured to receive one of the plural component color signals, wherein said plural chiral lasers are operable to emit light radiation therefrom to form a plurality of color light beams, each plural color beam being representative of a particular color component of the display image, wherein said plural pixellated chiral lasers are positioned in a stack configuration, such that when said plural pixellated chiral lasers are activated, said plural color light beams are combined into the display image for projection onto a surface.

23. The chiral laser projection apparatus of claim 22, wherein each plural pixellated chiral laser is substantially transparent to plural color beams from other plural pixellated chiral lasers that are projected therethrough.

24. The chiral laser projection apparatus of claim 22, wherein each said plural pixellated chiral laser comprise pixellation means for selectively causing each said plural pixellated chiral laser to only emit light radiation from a predefined portion thereof.

25. The chiral laser projection apparatus of claim 22, wherein said plurality of pixellated chiral lasers comprises a plurality of CLC film pixellated lasers.

26. The chiral laser projection apparatus of claim 22, wherein said plural component color signals comprise red, green and blue color signal components, and wherein said plural CLC film pixellated lasers comprise: a red CLC film pixellated laser, a green CLC film pixellated laser, and blue CLC film pixellated laser.

27. The chiral laser projection apparatus of claim 22, wherein said plural pixellated chiral lasers comprise means for optically pumping thereof.

28. The chiral laser projection apparatus of claim 22, further comprising electronic pumping means for electronically pumping said plural pixellated chiral lasers.

29. The chiral laser projection apparatus of claim 28, wherein said electronic pumping means comprises the signal source connected to said plural pixellated chiral lasers.

30. The chiral laser projection apparatus of claim 22, further comprising focusing means for focusing the display image in conjunction with said combining means.

31. The chiral laser projection apparatus of claim 22, wherein said surface comprises one of: a screen and a diffuse panel.

32. A chiral laser projection apparatus for projecting a display image derived from plural component color signals produced by a signal source connected thereto, comprising:
plural display means, each for receiving and displaying a particular plural component color signal; and
a plurality of chiral lasers, each corresponding to a particular plural display means, and each positioned proximal thereto, wherein said plural chiral lasers are operable to emit light radiation in conjunction with said plural display means to form a plurality of color light beams, each plural color beam being representative of a particular color component of the display image.

33. The chiral laser projection apparatus of claim 32, further comprising combining means for combining said plural color light beams into the display image for projection onto a surface.

34. The chiral laser projection apparatus of claim 32, wherein each said plural display means are one of: a pixellated display panel and a pixellator operable to selectively cause each said plural chiral laser to only emit light radiation from a predefined portion thereof.

36. A method for projecting a display image derived from plural component color signals produced by a signal source connected thereto, comprising the steps of:
(a) providing a plurality of display devices, each operable to receive and display a particular plural component color signal;
(b) providing a plurality of chiral lasers, each corresponding to a particular plural display device and each positioned proximal thereto,
(c) causing said plural chiral lasers to emit light radiation in conjunction with said plural display means to form a plurality of color light beams, each plural color beam being representative of a particular color component of the display image.

37. The method of claim 36, further comprising the step of:
(d) combining said plural color light beams into the display image for projection onto a surface.

38. The method of claim 36, wherein each said plural display device is one of: a pixellated display panel and a pixellator operable to selectively cause each said plural chiral laser to only emit light radiation from a predefined portion thereof.
